(19) United States
(12) Patent Application Publication
(10) Pub. No.: US 2008/0149699 A1
(43) Pub. Date: Jun. 26, 2008

(54) HANDHELD COLONY COUNTER

(76) Inventors: Nicole M. Smokowicz, Des Plaines, IL (US); Michael F. De Rossi, Lindenhurst, IL (US); Christopher Stvartak, Skokie, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/617,519

(22) Filed: Dec. 28, 2006

Related U.S. Application Data
(63) Continuation-in-part of application No. 29/275,393, filed on Dec. 22, 2006, now Pat. No. D564385.

(51) Int. Cl. G06C 1/00

(52) U.S. Cl. 235/123

(57) ABSTRACT

A handheld counter is provided having a housing forming an opening, and inner sheath, an engagement member, and a sensor. The inner sheath is located in said opening and movable relative to the housing. The inner sheath forms a cylindrical cavity for receiving a writing instrument. The engagement member is connected with the inner sheath and frictionally engages said writing instrument upon insertion of said writing instrument into said cavity. The sensor is positioned to detect movement of said inner sheath and generate a signal in response to movement of said inner sheath.

### REFERENCE TO RELATED APPLICATIONS

The present application claims priority to U.S. Design patent application Ser. No. 29/275,393, filed Dec. 22, 2006.

### BACKGROUND

The present invention relates to a counter, and in particular, a handheld counter for counting colonies with a writing instrument.

### SUMMARY

According to one aspect of the present invention, a handheld counter is provided. The handheld counter includes a housing forming an opening, an inner sheath, an engagement member, and a sensor. The inner sheath is located in the opening and movably connected to the housing. The inner sheath forms a cylindrical cavity for receiving a writing instrument. The engagement member is connected with the inner sheath and frictionally engages the writing instrument upon insertion of said writing instrument into said cavity. The sensor is positioned to detect movement of said inner sheath and generate a signal in response to movement of said inner sheath.

According to another aspect of the present invention, another handheld counter is provided. This handheld counter includes a housing forming an opening, and inner sheath, and a sensor. The inner sheath is located in the opening and movably connected to the housing. The inner sheath forms a cylindrical cavity sized to receive a writing instrument. The handheld counter also includes a finger movably connected with said inner sheath and projecting from said inner sheath into said cavity. A sensor is located in said housing and positioned adjacent the inner sheath.

### BRIEF DESCRIPTION OF THE DRAWINGS

FIG. 1 is a front perspective view of a handheld counter, in accordance with one embodiment;

FIG. 2 is a rear perspective view of the handheld counter of FIG. 1, in accordance with one embodiment;

FIGS. 3 is a rear perspective view of the handheld counter of FIG. 1 with a detached battery cover, in accordance with one embodiment;

FIG. 4 is an exploded side view of the handheld counter of FIG. 1, in accordance with one embodiment;

FIG. 5 is an inside view of the handheld counter of FIG. 1 having a front cover and a rear cover, in accordance with one embodiment;

FIG. 6 is an enlarged side view of the handheld counter of FIG. 4, in accordance with one embodiment;

FIG. 7 is an enlarged inner view of the handheld counter of FIG. 5, in accordance with one embodiment;

FIG. 8 is an enlarged exploded perspective view of the handheld counter of FIG. 1, in accordance with one embodiment;

FIG. 9 is an enlarged exploded side view of the handheld counter of FIG. 1, in accordance with one embodiment;

FIG. 10 is an enlarged exploded side view of the handheld counter of FIG. 1, in accordance with one embodiment;

FIG. 11 is an exploded perspective view of a handheld counter, in accordance with one embodiment;

FIG. 12 is a perspective view of an inner sheath from the handheld counter of FIG. 11, in accordance with one embodiment; and

FIG. 13 is a front view of a display panel from the handheld counter of FIG. 11, in accordance with one embodiment.

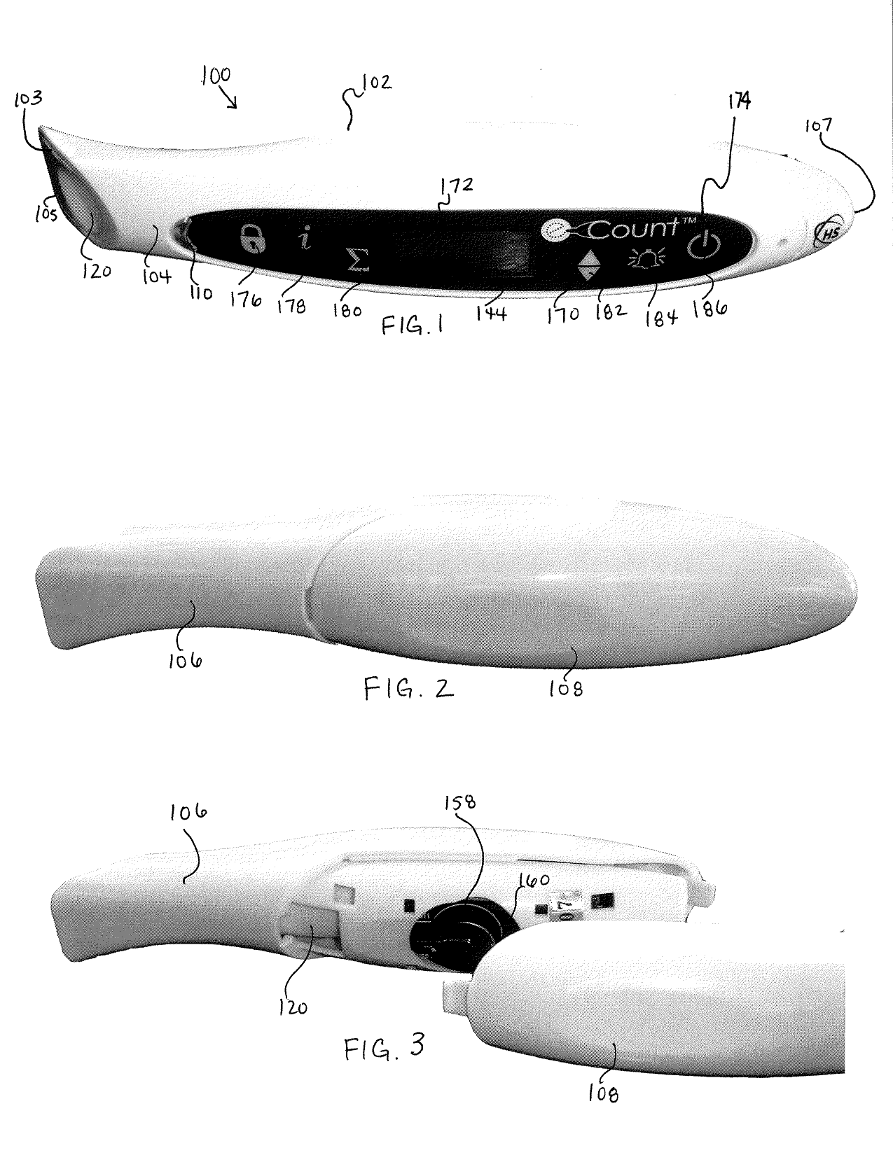

It should be appreciated that for simplicity and clarity of illustration, elements shown in the Figures have not necessarily been drawn to scale. For example, the dimensions of some elements may be exaggerated relative to each other for clarity. Further, where considered appropriate, reference numerals have been repeated among the Figures to indicate corresponding elements.

### DETAILED DESCRIPTION

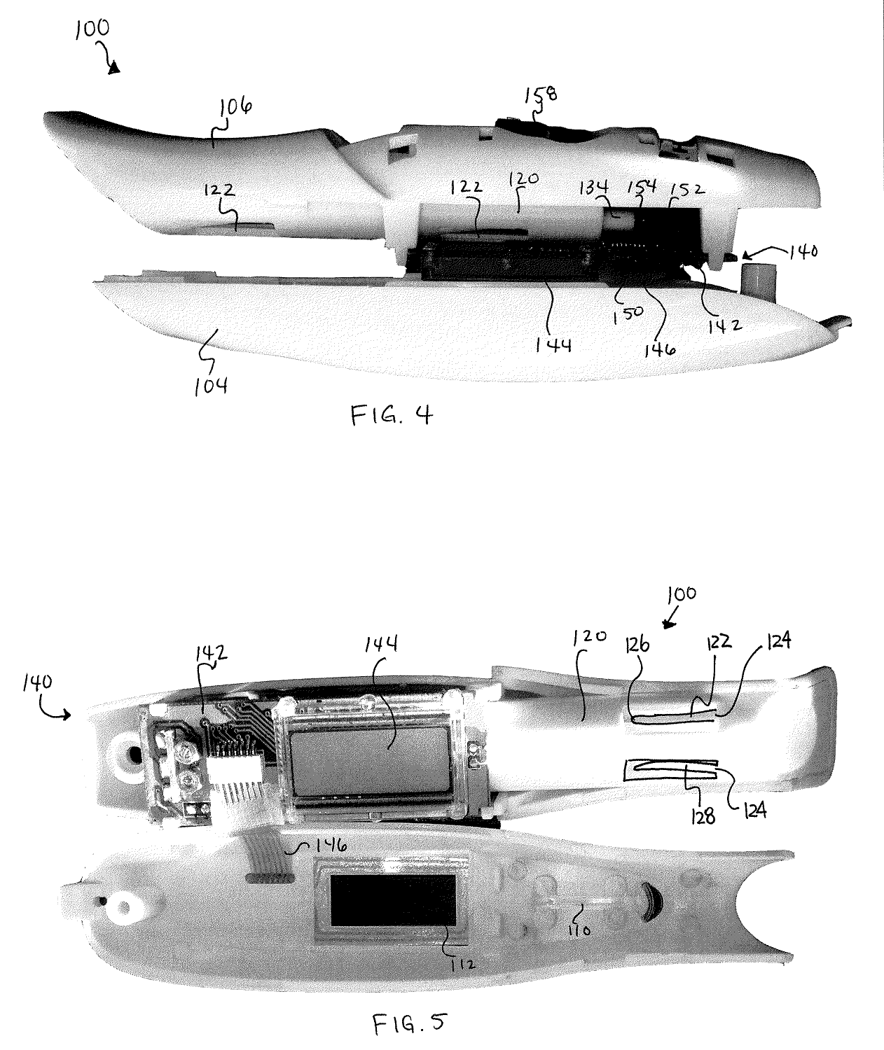

Shown in FIG. 1 is a front perspective view of a handheld counter 100 used to count and mark objects, such as colonies of bacteria in a Petri dish, in accordance with one embodiment. The handheld counter 100 has a housing 102 forming an opening 103 and an inner sheath 120 located in said opening. Housing 100 may be constructed as a single molded piece, by combining a plurality of pieces together, by stamping, welding, or any other methods for forming an outer shell. Housing 100 is formed from any suitable material or combination of materials, such as wood, plastic, rubber, glass, metal, ceramics, and other such materials. In one embodiment, housing 100 comprises a front cover 104 fixedly attached to a rear cover 106 using a snap-fit arrangement, as illustrated in FIGS. 1 and 4. Preferably, housing 100 also includes a battery cover 108 for covering a battery housing 158, as described below. The battery cover 108 is removably connected with the rear cover 106 and used to protect a battery 160 housed in the battery housing 158, as illustrated in FIG. 3. Preferably, the housing 100 is ergonomically shaped and balanced so as to fit in a human hand comfortably for easy counting, as illustrated in FIG. 1.

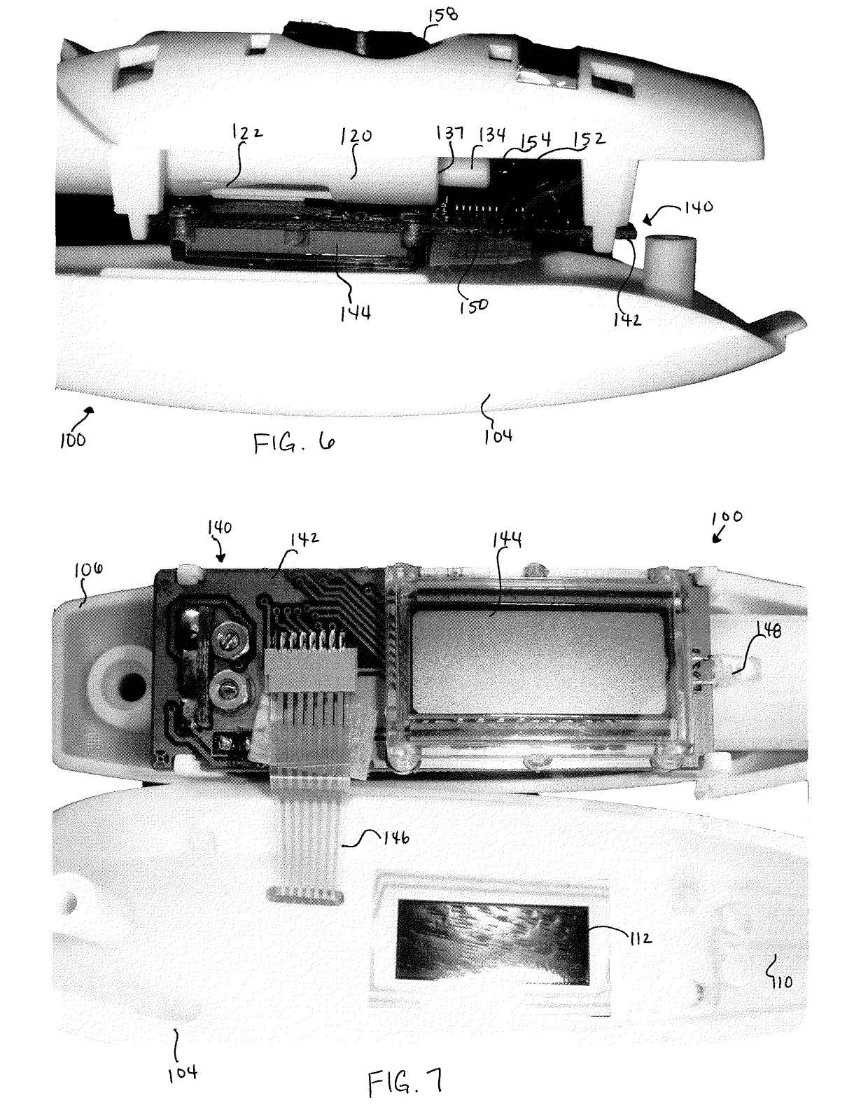

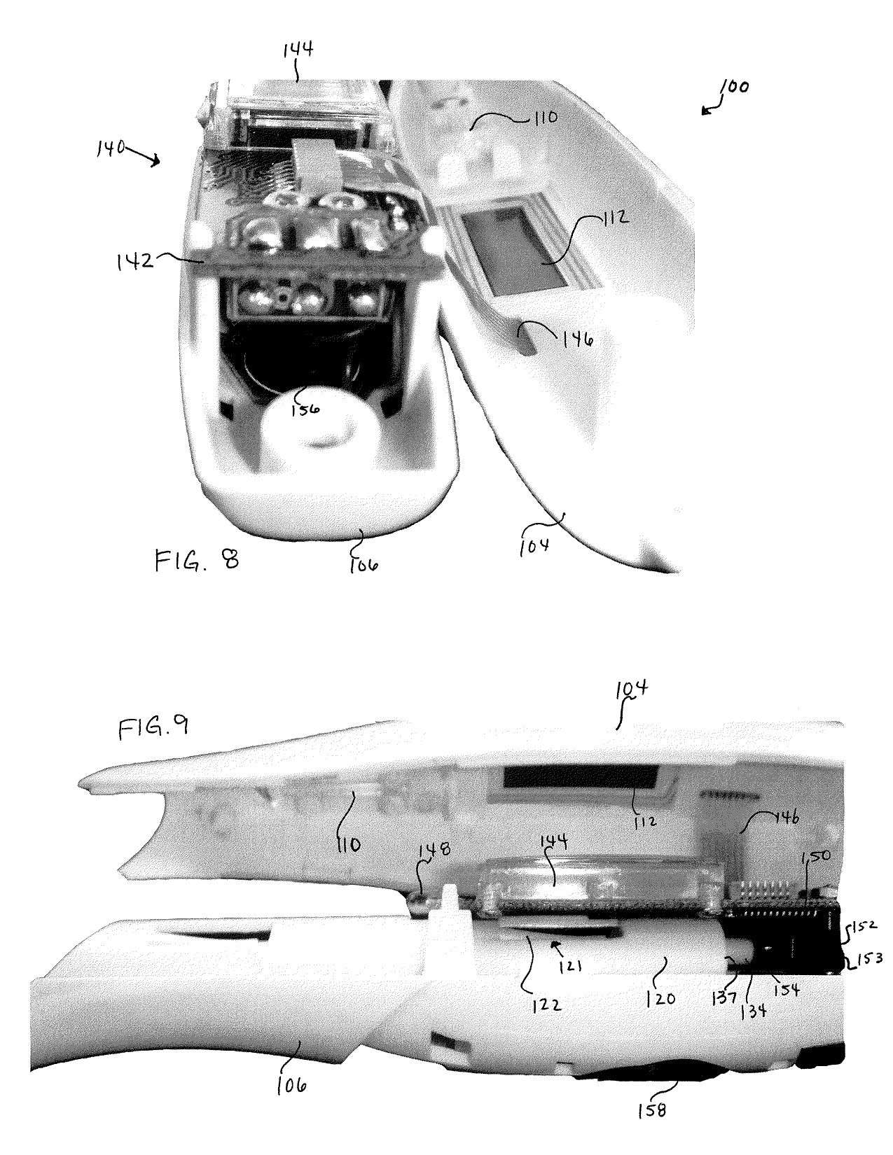

Opening 103 is located within the housing 100 and sized to receive the inner sheath 120, as illustrated in FIGS. 1 and 5. The inner sheath 120 is located in the opening 103 and movably connected to the housing 100. Preferably, the inner sheath 120 is biased in an inactive position by a biasing member which is a spring, not shown. However, the inner sheath 120 may be biased in an inactive position using other biasing members including a mechanical device such as a bent piece of metal, a magnetic device such as an electromagnet or a magnet, tensioned means such as a rubber band, and other such devices. In one embodiment, the handheld counter 100 includes a sensor 152 having a movable button 154 which is biased in an extended position, as shown in FIG. 6, and the movable button 154 is placed adjacent the inner sheath 120 and biases the inner sheath in an inactive position, as illustrated in FIG. 9. The biasing member biases the inner sheath 120 in the inactive position so that when the inner sheath 120 is placed in the active position, the biasing member exerts force on the inner sheath 120 to move the inner sheath back to the inactive position.

The inner sheath 120 is movable between the inactive position and an active position, upon which pressure is exerted on the inner sheath 120 in a direction from a tip 105 of the housing 100 to an end 107 of the housing 100. At the active position, the inner sheath 120 presses the movable button 154, causing the sensor 152 to generate a first signal indicating that a count is desired, as described below. In one embodiment, the inner sheath 120 includes a projecting member 134 which extends from an end 137 of the inner sheath 120 to the button 154, as illustrated in FIG. 9. The projecting member 134 engages the button 154 and presses the button when the inner sheath 120 is placed in the active position.

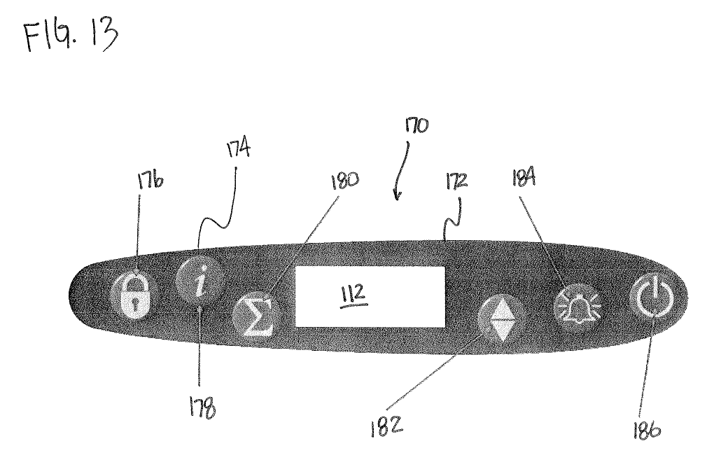

The inner sheath 120 may be constructed as a single molded piece, or may be constructed by combining a plurality of pieces together, by stamping, welding, a snap-fit arrangement, gluing, or any other methods for forming a singular body. The inner sheath 120 is formed from any suitable flexible material or combination of materials, such as wood, plastic, rubber, metal, and other such materials. Preferably, the inner sheath 120 is tubular in shape forming a cylindrical cavity 138 with an opening 135 in a face 139 and having a closed end 137, as illustrated in FIG. 12. Preferably face 139 is slanted or at an angle a which is other than 90 degrees with respect to a line 1-1 defining the longitudinal axis of the inner sheath 120 and formed in a direction from the face 139 to the end 137, as illustrated in FIG. 12. A slanted face 139 allows for a user to more easily insert a writing instrument 116 into the inner sheath 120, as illustrated in FIG. 11. The cylindrical cavity 138 is sized and shaped to removably receive a writing instrument 116, such as a pen, a pencil, a felt tip marker, a permanent marker, or the like. In one embodiment, the writing instrument 116 is a fall-sized writing instrument which may or may not be disposable. In one embodiment, the cylindrical cavity 138 is sized to receive a SHARPIE™ Brand fine point permanent marker, manufactured by Sanford Corporation of Oak Brook, Ill. In this embodiment, the cylindrical cavity 138 has an inner diameter of between 1 cm and 1.5 cm, and preferably, of between about 1.1 cm and 1.4 cm, and more preferably of about 1.3 cm. The cylindrical cavity 138 has a length from the front face 139 to the end 137 of approximately between 7.5 cm to 10.25 cm, and more preferably of between 8.25 cm and 9.50 cm, so as to be able to removably receive the writing instrument 116.

In one embodiment, the handheld counter 100 includes an engagement member 121 connected with the inner sheath 120, as illustrated in FIG. 12, to frictionally engage and hold the writing instrument within the cylindrical cavity 138. Preferably, the engagement member 121 is integrally formed as one piece with and of the same material composition as the remainder of the inner sheath 120. Preferably, the engagement member 121 is connected with the inner sheath 120 at at least one end. The engagement member 121 projects from said inner sheath 120 into said cylindrical cavity 138.

In one embodiment the engagement member 121 comprises a strip of material having opposing ends 124, 126 connected to the inner sheath 120 such that the engagement member 121 bows inwards into said cylindrical cavity 138, as illustrated in FIG. 12. By bowing inwards, the engagement member 121 is configured to press against and frictionally engage the writing instrument 116 upon insertion into the cylindrical cavity 138, as illustrated in FIG. 11.

In another embodiment, the engagement member 121 is formed as a finger 122 having a first end 124 movably connected with the inner sheath 120 and a second end 126 projecting inwards from said inner sheath 120 and into said cylindrical cavity 138, as illustrated in FIGS. 5 and 9. By projecting inwards, the finger 122 is configured to press against and frictionally engage the writing instrument 116 upon insertion into the cylindrical cavity 138. Preferably, the inner sheath 120 includes more than one engagement member 121 or finger 122, as illustrated in FIGS. 9 and 11.

In one embodiment, the counter 100 includes a plurality of engagement members 121 arranged circumferentially around the inner sheath 120 forming a ring of engagement members 121, as illustrated in FIG. 12, in order to circumferentially engage the writing instrument 116. In another embodiment, the counter 100 includes multiple rings of engagement members 121, as illustrated in FIG. 9. By frictionally engaging and securing the writing instrument 116 to the inner sheath 120 upon insertion of the writing instrument 116 into the cylindrical cavity 138, the engagement members 121 prevent the writing instrument from unexpectedly disengaging from the cylindrical cavity 138.

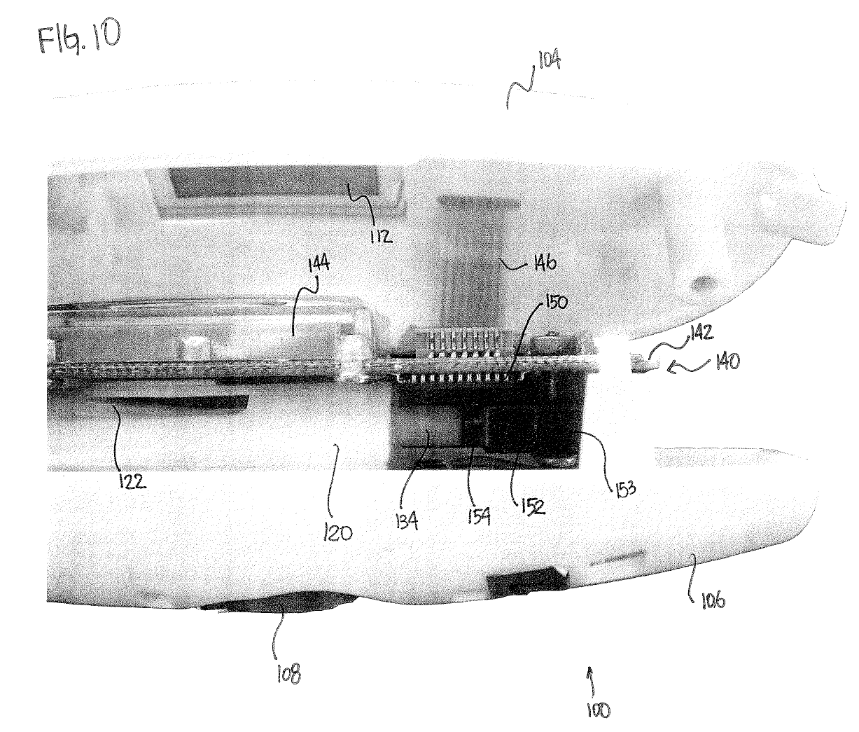

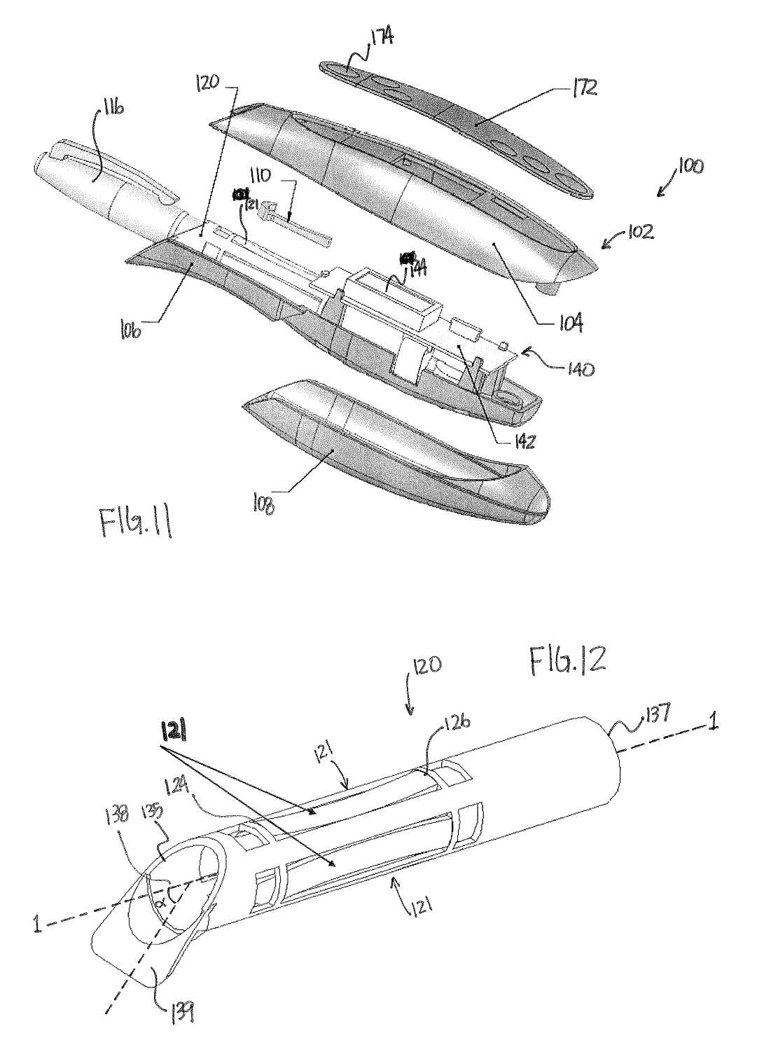

The counter 100 further includes electronic circuitry 140 for generating signals in response to movement of said inner sheath 120, indicating a count is desired, and providing and displaying a total count, as illustrated in FIGS. 4-11. The electronic circuitry 140 includes a sensor 152, a display 144, buttons 174, a controller 150, and a circuit board 142 for mounting the above listed electronic circuitry 140. The sensor 152 is positioned to detect movement of said inner sheath 120 and generate a signal in response to movement of said inner sheath 120. Sensor 152 can be any type of devices used to detect movement, including a Hall-Effect Sensor, a micro-switch actuated by a movable button 154 as shown in FIG. 10, an electrical contact, a light sensor, and any other such device. The sensor 152 is mounted on the circuit board 142 and electronically connected with the controller 150.

In one embodiment, the sensor 152 includes a micro-switch 153 actuated by a movable button 154. At the active position, the inner sheath 120, and more specifically a projecting member 134 extending from an end 137 of the inner sheath 120, presses the movable button 154, causing the sensor 152 to generate a first signal indicating that the inner sheath 120 has moved from the inactive position to the active position and that a count is desired. Preferably, the sensor 152 is a micro-switch sensor manufactured by Omron Corporation located in Tokyo, Japan.

Display 144 is used to displaying alphanumeric characters representing things such as a total count, whether or not the device is locked, the zone to be counted, the sum total of all counts in memory, and the count direction. The display 144 can be any type of display used to represent information, including a liquid crystal display, a plasma display, an electronic ink display, a display comprised of light emitting diodes, a cathode ray tube, and other such displays. Preferably a low power, light weight display such as a liquid crystal display or an electronic ink display is used. Display 144 is mounted on the circuit board 142 and electronically connected with the controller 150.

As shown in FIGS. 11 and 13, buttons 174 are electronically connected with the controller 150 and when pressed may cause information to be displayed or changed on the display 144. The buttons 174 may be formed by a variety of techniques. In one embodiment, the buttons 174 are molded into or pressed into a membrane 172, as shown in FIGS. 11 and 13. Additionally, wiring is provided to each button 174 so that when the button 174 is pressed, a signal corresponding to that button is sent to the controller 150 through a wiring harness 146 which is illustrated in FIG. 7. In one embodiment, the buttons 174 comprise a lock button 176 for disabling and preventing the counter 100 from generating a count. The lock button 176 allows for the user to take notes with the writing instrument 116 while it is still inside the cavity 138 of the inner sheath 120 and without inadvertently changing any data or information within a memory of the counter 100. Buttons 174 also include a zone button 178, a sum button 180, a direction button 182, an alert button 184, and a power button 186.

The zone button 178 toggles among a number of counting zones, i.e. 32 counting zones, so that a user may keep a number of counting zones in the memory. For example, the user may be able to keep track of a first count for a first colony, and a second count for a second item such as a second colony. The sum button 180 displays the total of all counts in the memory of the counter 100. Therefore, for example, if a user would like to know what the total of the counts for a first colony and a second colony, a user could press the sum button 180 and the counter 100 would add the total count for the first colony with the total count for the second colony to arrive at a total of all counts in the memory of the counter 100. The direction button 182 toggles between counting up towards a high number, i.e. 999, and counting down towards a low number, i.e. −999 depending on the user's preference or task. The alert button 184 toggles the controller 150 between a “flash mode,” where each count is indicated to the user by flashing the light source 148 on and off, and a “beep mode,” where each count is indicated to the user by sounding the speaker 156. A count is registered when the user depresses the writing instrument when located inside the cavity 138 and causes the inner sheath 120 to move from an inactive position (i.e. a position where there is little or no engagement between the projecting member 134 and the movable button 154) to an active position (i.e. a position where there is substantial engagement between the projecting member 134 and the movable button 154). The power button 186 turns the counter 100 on and off. In one embodiment, turning the counter 100 off clears or erases the memory of the counter 100. Preferably, the memory is located in the electronic circuitry 140 of the counter 100, and more preferably mounted to the circuit board 142. In one embodiment, the memory is located in the controller 150.

The controller 150 receives commands from the buttons 174 and the signal from the sensor 152 and outputs information to the display 144 in response to either. In one embodiment, controller 150 is an 8-bit microcontroller manufactured by Elan Microelectronics Corporation of Taiwan, having part number EM78P468NBQS. The controller 150 operates the display 144, receives signals indicating a count from the sensor 152, adds successive signals to obtain a total count, and stores the total count in memory, and outputs the total count on the display 144. The total count increases each successive time the sensor 152 generates a signal. Upon activating the lock button 176, the controller 150 insures that the total count is not increased regardless of whether the inner sheath 120 is in an inactive position or in an active position.

In one embodiment, a method for counting is provided. The method includes first providing a handheld counter 100 having a housing 102 forming an opening 103, an inner sheath 120 located in the opening 103 and movably connected to the housing 102, the inner sheath 120 forming a cylindrical cavity 138 for receiving a writing instrument 116, and a sensor 152 positioned to detect movement of the inner sheath 120 and generate a signal in response to movement of the inner sheath 120. The method also includes then placing the writing instrument 116 inside the cavity 138 and first tapping the writing instrument 116 against a surface. Upon tapping the writing instrument 116 against a surface, a first signal is generated by the sensor 152 in response. The first signal is then stored in memory by the controller 150 and then the controller 150 generates a total count as a result of receiving the first signal. A second signal is then generated in response to a second tapping of the writing instrument 116 against a surface. The controller 150 then increases the total count by one as a result of the second signal. In one embodiment, the lock button 176 may be depressed or activated, wherein upon activating the lock button 176, the total count is not increased as a result of successive signals which are later generated in response to any further tapping. If the lock button 176 is depressed a second time, then the controller 150 will increase the total count by one as a result of any successive signals received. Upon placing the writing instrument 116 inside the cavity 138, an engagement member 121, such as a finger 122, is flexed and moved in a direction from inside the cavity 138 towards said inner sheath 120 to hold it in place.

In one embodiment, a kit for counting items, such as bacterial colonies, is provided. The kit includes the handheld counter 100 having a housing 102 forming an opening 103, an inner sheath 120 located in the opening 103 and movably connected to the housing 102. The inner sheath forms a cylindrical cavity 138 sized to receive the writing instrument 116. The counter 100 includes an engagement member 121, preferably a finger 122, movably connected with the inner sheath 120 and projecting from the inner sheath 120 into the cavity 138. A sensor 152 is located in the housing 102 and positioned adjacent the inner sheath 120. The kit also includes a writing instrument 116. Preferably, the cavity 138 is configured and arranged to receive the writing instrument 116.

As will be appreciated by those of skill in this art, the preceding examples are provided, not to limit or define the scope of the present invention, but to illustrate the nature of the present invention and possible uses for the teachings of the present invention. These examples may be modified in many different ways while still obtaining the benefits of the teachings of the present invention. While the invention has been described and illustrated, this description is by way of example only. Additional advantages will occur readily to those skilled in the art, who may make numerous changes without departing from the true spirit and scope of the invention. Therefore, the invention is not limited to the specific details, representative machines, and illustrated examples in this description. Accordingly, the scope of this invention is to be limited only as necessitated by the accompanying claims. Various features and advantages of the invention are set forth in the following claims.

What is claimed is:

1. A handheld counter comprising:
a housing forming an opening;
an inner sheath located in said opening and movable relative to said housing, said inner sheath forming a cylindrical cavity for receiving a writing instrument;
an engagement member connected with the inner sheath which frictionally engages said writing instrument upon insertion of said writing instrument into said cavity; and
a sensor connected with the housing and positioned to detect movement of said inner sheath and generate a signal in response to movement of said inner sheath.

2. A handheld counter according to claim 1 further comprising a display for displaying alphanumeric characters, a button connected with said display, and a controller for receiving commands from said button and said signal from said sensor and outputting information in response onto said display.

3. A handheld counter according to claim 1, wherein said engagement member is connected with said inner sheath at one end and projects from said inner sheath into said cavity.

4. A handheld counter according to claim 1, wherein said inner sheath includes a plurality of engagement members which are circumferentially arranged around said inner sheath, and wherein each engagement member is movably connected with said inner sheath at one end and projects from said inner sheath into said cavity.

5. A handheld counter according to claim 2, wherein said controller, upon receipt of said signal from said sensor, generates a total count and outputs said total count on said display, wherein said total count increases each successive time said sensor generates a signal.

6. A handheld counter according to claim 5, further comprising a lock button connected with said controller, wherein upon activating said lock button, said total count is not increased.

7. A method for counting comprising:
providing a handheld counter having a housing forming an opening and an inner sheath located in said opening and movable relative to said housing, said inner sheath forming a cylindrical cavity for removably receiving a writing instrument, said handheld counter further includes a sensor positioned to detect movement of said inner sheath and generate a signal in response to movement of said inner sheath;
placing a writing instrument inside said cavity;
first tapping said writing instrument against a surface; and
generating a first signal in response to said first tapping of said writing instrument.

8. The method of claim 7, wherein said handheld counter includes an engagement member which frictionally engages said writing instrument upon insertion of said writing instrument into said cavity.

9. The method of claim 7 further comprising storing said first signal in a memory and generating a total count as a result of said first signal.

10. The method of claim 7 further comprising generating a second signal in response to a second tapping of said writing instrument, and increasing said total count by one as a result of said second signal.

11. The method of claim 7 further comprising activating a lock button, wherein upon activating said lock button said total count is not increased as a result of signals generated in response to said tapping.

12. The method of claim 7, wherein said handheld counter further includes a finger movably connected with said inner sheath and projecting from said inner sheath into said cavity.

13. The method of claim 12 further comprising moving said finger in a direction from into said cavity and towards said inner sheath upon the placing of a writing instrument inside said cavity.

14. A kit for counting comprising:
a handheld counter having a housing forming an opening, an inner sheath located in said opening and movable relative to said housing, said inner sheath forming a cylindrical cavity sized to receive a writing instrument, wherein said handheld counter further includes an engagement member movably connected with said inner sheath and projecting from said inner sheath into said cavity, and said handheld counter further includes a sensor located in said housing and positioned adjacent said inner sheath; and
a writing instrument, wherein said cavity is configured to receive said writing instrument.

15. A kit for counting according to claim 14, wherein said writing instrument is one of a permanent marker, a pen, and a pencil.

16. A kit for counting according to claim 14, wherein said handheld counter further comprises a display for displaying alphanumeric characters, a button connected with said display, and a controller for receiving commands from said button and said signal from said sensor and outputting information in response onto said display.

17. A kit for counting according to claim 16 further comprising a lock button connected with said controller, wherein upon activating said lock button, said total count is not increased.

18. A kit for counting according to claim 14, wherein said engagement member is a finger.

19. A handheld counter comprising:
a housing forming an opening;
an inner sheath located in said opening and movable relative to said housing, said inner sheath forming a cylindrical cavity sized to receive a writing instrument;
a finger movably connected with said inner sheath and projecting from said inner sheath into said cavity; and
a sensor located in said housing and positioned adjacent said inner sheath.

20. A handheld counter according to claim 19, wherein said sensor generates a signal in response to said movement of said inner sheath.

21. A handheld counter according to claim 20 further comprising a display for displaying alphanumeric characters, a button for locking said counter, and a controller for receiving commands from said button and said signal from said sensor and outputting information in response onto said display.

22. A handheld counter according to claim 19, wherein said finger is connected at two ends to said inner sheath and bows inwards into said cavity.

23. A handheld counter according to claim 20 further comprising a projecting member extending from said inner sheath, said projecting member movable relative to said sensor.
